(19) United States
(12) Patent Application Publication
(10) Pub. No.: US 2026/0283084 A1
(43) Pub. Date: Sep. 24, 2026

(54) SYSTEMS, APPARATUSES, AND METHODS FOR PASTEURIZATION TUNNEL MINIATURIZATION

(71) Applicant: Hedgehog Foods, Inc., East Palo Alto, CA (US)

(72) Inventors: Wilson Ruotolo, San Francisco, CA (US); Michael King, San Francisco, CA (US); Ben Van de Vorle, Utrecht (NL)

(21) Appl. No.: 19/562,682

(22) Filed: Mar. 10, 2026

Related U.S. Application Data
(60) Provisional application No. 63/776,869, filed on Mar. 24, 2025.

(51) Int. Cl. A01G 18/30

(52) U.S. Cl. CPC A01G 18/30

(57) ABSTRACT

Provided are small-scale pasteurization tunnel systems and methods for microbial pasteurization of growth substrate. The system includes an insulated container and an insulated lid, forming an airtight inner chamber, wherein growth substrate is placed within the inner chamber for pasteurization. An air circulation subsystem includes an air circulation loop which directs airflow through the substrate, a circulation fan which controls the speed and direction of airflow, a fresh air inlet to provide fresh air, a return air damper to control return air flow, a fresh air damper to control input of fresh air, an exhaust port to allow air to pass from the inner chamber to an exterior of the insulated container; and a control subsystem for monitoring data from a plurality of sensors and controlling the circulation fan, the return air damper and the fresh air damper. The system may also include a heating subsystem to provide thermal energy.

### TECHNICAL FIELD

The embodiments disclosed herein relate to fungi cultivation and, in particular to systems, apparatus, and methods for fungi growth substrate pasteurization.

### BACKGROUND

Agaricus mushrooms are the only mushroom species grown in bulk on microbially pasteurized substrate. This is because they are secondary decomposers and need the substrate to be predigested by microbes to be able to access the nutrients. Microbial pasteurization provides sterilization or simple hot pasteurization, and can be performed less expensively in bulk due to energy savings and lack of reliance on sealed, pressurized chambers. The method confers a greater level of contamination resistance to the resulting substrate, which, in turn, allows for less expensive bulk inoculation and cultivation to be feasible in larger volumes rather than in small, sealed bags or bottles.

This contamination resistance stems from a variety of factors. Nitrogen is converted into formats more favorable for the mushroom and less favorable for bacteria or competitive molds. Simple sugars are digested into less accessible formats. Competitive microorganisms are killed off while a rich population of helpful microbes is maintained and amplified. These beneficial microbes can potentially improve yield, improve grow speed, and help fight off other competitor organisms.

While it would be beneficial to grow other varieties of fungi on this class of substrate, the desired pasteurization procedures, recipes, and formulations for non-agaricus species are unknown. The ability to test these procedures, recipes, and formulations on non-agaricus species is currently limited by the lack of small scale apparatuses and methods for testing possible parameters.

Accordingly, there is a need for systems, apparatuses, and methods for small scale pasteurization of mushroom growth substrate.

### SUMMARY

Provided herein is a small scale pasteurization tunnel system for microbial pasteurization of growth substrate comprising an insulated container and an insulated lid, wherein when the insulated lid is positioned to close the insulated container, an airtight inner chamber is formed by the insulated container and the insulated lid, wherein growth substrate is placed within the inner chamber for pasteurization; an air circulation subsystem comprising: an air circulation loop comprising airtight ducting which directs airflow through the substrate, wherein air flows out of a first end of the air circulation loop into the substrate and air flows out of the substrate and into a second end of the air circulation loop, a circulation fan which controls the speed and direction of airflow through the air circulation loop, a fresh air inlet which connects to the air circulation loop to provide fresh air, a return air damper which controls a resistance of return air entering into the air circulation loop at the second open end, a fresh air damper which controls a resistance of fresh air entering into the air circulation loop, an exhaust port to allow air to pass from the inner chamber to an exterior of the insulated container; and a control subsystem for monitoring data from a plurality of sensors and controlling the circulation fan, the return air damper and the fresh air damper.

The system may further comprise a cartridge system, wherein at least one cartridge may be placed within the inner chamber, and wherein the at least one cartridge holds substrate and allows air to flow through the substrate. At least two cartridges are placed within the inner chamber and wherein pasteurization parameters within each of the at least two cartridges are different.

An R value of the insulated container and insulated lid may be at least 20.

The insulated container and insulated lid may comprise PIR/PUR material.

The system may further comprise a heating subsystem for providing thermal energy to facilitate microbial activity within the substrate, wherein the heating subsystem is controlled by the control subsystem.

The heating subsystem may be a heater. The heater may employ at least one of convection, conduction, or radiation.

The heating subsystem may be a steam injection system.

The control subsystem may include an oxygen sensor to measure oxygen levels. The oxygen sensor may be positioned within the air circulation loop to measure oxygen levels just after the second opening. A second oxygen sensor may be positioned within the air circulation loop to measure oxygen levels just before the first opening.

The control subsystem may include a carbon monoxide sensor to measure carbon monoxide levels.

The control subsystem may include a carbon dioxide sensor to measure carbon dioxide levels.

The control subsystem may include at least one airflow sensor measure of flow rate of the air through the air circulation subsystem. The at least one airflow sensor may comprise a pitot tube.

The air circulation loop may comprise an extended section to create laminar flow for measurement by the pitot tube.

The control subsystem may include at least one temperature sensor to measure a temperature of the substrate.

The control subsystem may include a plurality of temperature sensors within the substrate to measure a temperature gradient across the substrate. Airflow may be controlled based on the temperature gradient.

The control subsystem may include at least one temperature sensor to measure a temperature of the air.

The control subsystem may include at least one humidity sensor to measure a water level of the air within the inner chamber.

The control subsystem may include at least one moisture sensor to measure a water level within the substrate.

The air circulation loop may include ports for sensors.

Provided herein is a method of operating a miniature pasteurization tunnel comprising an insulated container, an air circulation subsystem, and a control subsystem, the method comprising: placing at least one volume of substrate on a platform within the insulated container, wherein the platform comprises a plane of permeable membrane above a plenum, sealing the insulated container with an insulated lid, controlling substrate parameters of the at least one volume of substrate by the control subsystem based on a plurality of experimental parameters, wherein the substrate parameters include at least temperature and oxygen level, and wherein the control subsystem controls the substrate parameters by: generating sensor data from a plurality of sensors within the pasteurization tunnel, wherein the plurality of sensors includes at least one temperature sensor and at least one oxygen sensor, and controlling air flow through an air circulation loop of the air circulation subsystem and through the at least one volume of substrate by actuating a return air damper of the air circulation loop, a fresh air damper of a fresh air inlet of the air circulation subsystem, and a circulation fan of the air circulation subsystem based on the sensor data from the at least one temperature sensor and the at least one oxygen sensor.

The pasteurization tunnel may further comprise a heating subsystem and controlling the temperature of the substrate may further comprise controlling the heating subsystem, by the control subsystem, to provide thermal energy to the substrate.

The heating subsystem may comprise a heater to provide thermal energy by at least one of conduction, convection, and radiation.

The heating subsystem may provide thermal energy by steam injection.

The plurality of sensors may include at least one airflow sensor to measure airflow throughout the pasteurization tunnel.

The plurality of sensors may include at least one moisture sensor to measure a water level within the substrate.

The plurality of sensors may include at least one humidity sensor to measure a water level within the air.

The control subsystem may automatically control the pasteurization tunnel.

The control subsystem may require manual input to control the pasteurization tunnel.

The experimental parameters may be determined using artificial intelligence (AI) computational optimization. Computational optimization may be performed using Bayesian optimization.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic view of a pasteurization tunnel, according to one embodiment.

FIG. 2 is a flow diagram of a method of operating a pasteurization tunnel, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical, and some steps may be performed simultaneously. Some steps may not be performed.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

As used in the specification and claims, the singular forms “a”, “an” and “the” include plural references unless the context clearly dictates otherwise. For example, the term “a sample” includes a plurality of samples, including combinations thereof.

The terms “comprise,” “have,” and “include” are open-ended linking verbs. Any forms or tenses of one or more of these verbs, such as “comprises,” “comprising,” “has,” “having,” “includes,” and “including,” are also open-ended. For example, any method that “comprises,” “has,” or “includes” one or more steps is not limited to possessing only those one or more steps and also covers other unlisted steps. The term “and/or” includes all of the items listed as well as any combinations of the items listed.

As described above there is an unmet need for systems and methods of determining which parameters for microbial pasteurization of growth substrate will be functional and optimal for other varieties of fungus.

The parameters of pasteurization may include substrate recipes/formulations, substrate particle size and/or shape, pasteurization times, pasteurization temperatures, moisture content, form factor, air flow, etc. For different varieties of fungi, these parameters may vary greatly from those of the agaricus process. Therefore, large batch testing for pasteurization of substrate for all of the variable parameters is not economical.

Provided herein are pasteurization tunnels which are capable of performing the pasteurization process at roughly 1/500^{th} the scale of typical pasteurization tunnels, thus enabling high throughput testing of the various parameters and permutations thereof.

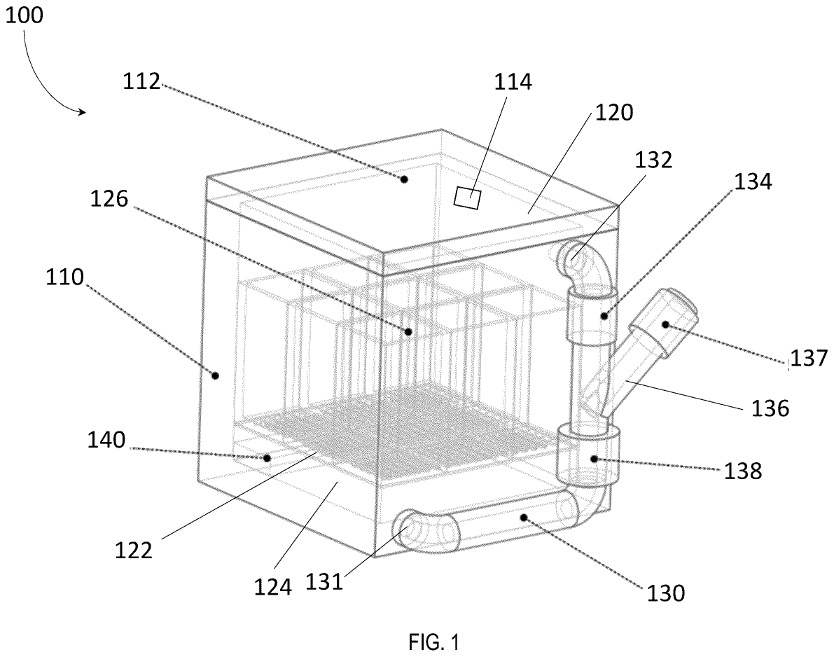

Referring to FIG. 1, illustrated therein is a pasteurization tunnel 100 for high throughput testing of pasteurization parameters.

The pasteurization tunnel 100 includes an insulated container 110 with a lid 112 and an inner chamber 120, a platform 122, a plenum 124, a cartridge system 126, an air circulation subsystem comprising: an air circulation loop 130, a return air damper 132, a fresh air inlet 134, a fresh air damper 136, and a circulation fan 138, a heating subsystem 140, and a control subsystem (not shown).

The insulated container 110 has an R value appropriate for the temperature parameters for the pasteurization of the substrate. For example, the R value may be approximately 20. Temperature is a parameter which can be altered within the pasteurization tunnel 100. Therefore, in a preferred embodiment, the R value of the pasteurization tunnel would be sufficient to prevent significant heat loss at the highest possible temperature reached during pasteurization. In other embodiments, the insulation chamber may have a lower R value to be used for substrate pasteurization tests at lower temperatures (i.e., at a temperature lower than the max temperature which could possibly be reached during pasteurization).

Additionally, the R value of the insulation may be dependent on the exterior conditions which the pasteurization tunnel 100 will exist within. That is, if the pasteurization tunnel will be in a warmer climate or environment then a lower R value of insulation is required compared to the insulation of a pasteurization tunnel which will be within a colder climate or environment.

The material of the insulation container 110 may be PIR/PUR insulation. The thickness of the insulation may be 3 inches. In other embodiments, the material may be different and the thickness of the material may be different.

The walls of the insulation container 110 may comprise only the insulation material. In other embodiments, the insulation container may comprise a cover or coating on the exterior. In other embodiments, the insulation container may comprise a cover or coating on the interior. The cover or coating may be easily cleanable or naturally sterile.

The lid 112 of the pasteurization tunnel 100 also comprises insulation having the same R value as the insulation of the insulation container 110. The lid 112 may have a gasket or other type of seal to ensure that the inner chamber 120 is airtight. The lid may be a door or hatch which is connected to the insulation container 110 by at least one hinge.

The inner chamber 120 is a space into which substrate is deposited for pasteurization. At the bottom of the inner chamber there is a platform 122 comprising a permeable solid plane which holds the substrate. The permeable solid plane is permeable to air and moisture but it is not permeable for the substrate. The permeability of the solid plane may vary and may be chosen based on a minimum particle size of the substrate. Below the platform is a plenum 124.

The inner chamber 120 may have a volume which allows for 200-300 kg of substrate to be pasteurized in a single trial. In other embodiments, the volume of the substrate may be less than 200 kg.

In the embodiment of FIG. 1, a cartridge system 126 is used within the inner chamber. The cartridge system 126 includes nine containers or “cartridges” arranged in a 3×3 grid. Each of the cartridges can hold an isolated volume of substrate such that different parameters can be applied to the substrate within each container. That is, the cartridge system 126 allows for distinct substrate formulations to be pasteurized under identical conditions without mixing of the separate substrates. For example, the recipe of the substrate may be different in each of the nine containers. In the embodiment of FIG. 1, each cartridge has four walls with an open top and bottom to allow air flow through the substrate within the cartridge. In other embodiments the cartridge may be a different shape, for example, a cylindrical shape with an open top and bottom.

The cartridges may be removable from the inner chamber 120.

In other embodiments the cartridge system may include any number and size of cartridges which can fit into inner chamber 126, as long as the cartridges allow air flow through the substrate and isolation of substrate from other cartridges. As well, different sizes of cartridge may be present within the inner chamber at the same time. For example, the cartridges may be in a 2×2 grid, the cartridges may be the same size as in FIG. 1 but less than nine are present, the cartridges may be small to allow for tens or hundreds of different formulations to be tested simultaneously, etc.

In other embodiments, any other form of substrate separation to keep units of substrate separated may be used.

As an example of size, the size of each cartridge may be 1 foot by 1 foot with a depth of 1.5 feet. As another example, the size of each cartridge could be 2 inches by 2 inches.

As the cartridges may be open at the top and bottom, without any barrier, cross-contamination of the cartridges may occur. In some embodiments, cross-contamination is fine, while in other embodiments cross contamination may be an issue which may be solved by providing air and moisture permeable barriers at the top and possibly bottom of the cartridges.

In other embodiments, there may be no cartridges of a cartridge system present and the entire capacity of the inner chamber may be used for a trial of parameters on a single volume of substrate.

As described above the pasteurization tunnel 100 includes an air circulation subsystem comprising an air circulation loop 130, a first open end 131, a second open end 132, a return air damper 134, a fresh air inlet 136, a fresh air damper 137, and a circulation fan 138.

The air circulation loop 130 may comprise airtight or near airtight ducting on the outside of the insulation container 110 and allows for air to flow from the top of the substrate material back to the bottom of the substrate material. In other embodiments, the air circulation loop may be entirely within the insulation container 110. In other embodiments, the air may flow from the top to the bottom of the substrate.

In the embodiment of FIG. 1, the air circulation loop 130 connects, at a first open end 131 of the air circulation loop, to a wall of the insulation container at a position below the bottom of the substrate material to provide an inlet for air into the inner chamber 120, and connects, through a second open end 132 of the air circulation loop, to a wall (could be the same wall as the inlet or a different wall) of the insulation container at a position above the top of the substrate material to provide an outlet for air from the inner chamber 120.The return air damper 134 controls the resistance of return air into the air circulation loop 130, which controls the return air to fresh air ratio, as fresh air is brought into the air circulation subsystem via the fresh air inlet 136. The fresh air inlet 136 comprises ducting which splits from the air circulation loop. The fresh air damper 137 controls the resistance of fresh air into the fresh air inlet. The ratio of return air to fresh air as coordinately controlled by the return air damper 134 and the fresh air damper 137 and regulates the temperature within the inner chamber 120 and the substrate.

The fresh air inlet 136 may include a filter. The filter may be a MERV 13 filter, a HEPA filter, etc., with the specific type of filter depending on the pasteurization and substrate parameters as well as the external environment of the pasteurization tunnel 100 (e.g., the source of the fresh air).

As fresh air is brought into the pasteurization tunnel 100, air passes out of the system through an exhaust port 114 in the insulation container 110. The exhaust port may be in a wall of the insulation chamber 110 or could be in the lid 112. In some embodiments with alternative configurations of the air circulation subsystem, the exhaust port may be in the bottom of the insulation chamber. The exhaust port may or may not include a filter.

As described above, in the embodiment for FIG. 1, the direction of air flow within the air circulation loop is into the plenum 126 at the bottom of the inner chamber and out of the top of the inner chamber such that air flows from the bottom to the top of the substrate. This airflow direction is accomplished by the circulation fan 138 which is positioned below the fresh air inlet 136. The circulation fan creates pressure and flow which forces air through the substrate. The pressure also pulls air into the system from the fresh air inlet 136 insomuch as the fresh air damper 137 allows. The circulation fan ensures that air flows through all of the substrate evenly (whether there is a single unit of substrate or multiple units within different cartridges).

In some embodiments, the direction of air flow may be from the top of the substrate to the bottom of the substrate.

In some embodiments, the air circulation loop may be entirely within the insulation container 110, and, therefore, there the air circulation loop would not pass through the wall. The return air damper would be within the insulation container 110. The circulation fan would be within the insulation container 110. The fresh air inlet would pass through the wall of the insulation container 110 while the fresh air damper may be outside of the insulation container 110 or within the insulation container 110.

In yet other embodiments, the air circulation subsystem and associated components may be in any configuration which allows for air to flow through the substrate, through the air circulation loop, and back through the substrate continuously. For example, the vertical cartridge system of FIG. 1 could be a horizontal system wherein the plenum is on one side of the insulated chamber and air flows horizontally through the substrate. The embodiment of FIG. 1 is an example embodiment, and is not meant to limit the configuration of pasteurization tunnel 100.

The heating subsystem 140 provides a source of thermal energy. Compared to conventional bulk pasteurization tunnels, the pasteurization tunnel 100 of FIG. 1 has lower volume to surface area ratios, as well formulations of substrate may have lower nitrogen content than those necessary for growing agaricus. Therefore, some sets of pasteurization parameters may require additional thermal energy (beyond what is provided by microbial activity) to enable the microbial ecosystem to reach pasteurization temperatures. In some embodiments, the thermal energy from the heating subsystem 140 may not be the primary source of heat, but rather a means of boosting microbial activity where necessary. In some embodiments, the thermal energy from the heating subsystem 140 may be the primary source of heat.

In some embodiments, the heating subsystem 140 may be a heater which heats air through convection. In some embodiments the heater may heat the substrate through conduction or radiation. In some embodiments, the heating subsystem 140 may be a steam injection system. In other embodiments, the pasteurization tunnel 100 may not include a heating subsystem.

The control subsystem (not shown) is integrated into the pasteurization tunnel 100 and comprises a plurality of sensors which provide data to a computer system which controls the actuators within the pasteurization tunnel 100 including the return air damper 134, the fresh air damper 137, the fan 138, and the heating subsystem 140.

The control subsystem may employ any combination of controllers (e.g., microcontrollers, programmable logic controllers, etc.), breakout boards, sensors, etc., which enable the control subsystem to appropriately control the actuators and therefore the parameters of environment of the inner chamber 120.

The plurality of sensors may include oxygen sensors, carbon monoxide and/or dioxide sensors, temperature sensors, airflow sensors, and moisture/humidity sensors.

An oxygen sensor provides data on the oxygen levels within the pasteurization tunnel 100. An oxygen sensor may be placed in the air circulation loop 130 after the second open end 132 of the insulation container 110 to measure oxygen levels of air leaving the inner chamber 120. In other embodiments, the oxygen sensor may be in other locations. In other embodiments, there may be multiple oxygen sensors. For example, an oxygen sensor may be within the fresh air inlet 136, or within the air circulation loop 130 after the fresh air inlet.

The data from the oxygen sensor(s) is used to regulate conditions inside the inner chamber 120 to ensure that sufficient oxygen is present for the desired microbial processes, e.g., levels of aerobic vs. anaerobic activity. If oxygen levels are too low within the inner chamber 120, the amount of fresh air being let in by the fresh air damper 136 may be increased and/or the rotations per minute (rpm) of the circulation fan 138 may be increased to raise the level of oxygen in the inner chamber 120.

In some embodiments, carbon monoxide or dioxide sensors may be present at the same or different locations as the oxygen sensors to provide more information which can be used to regulate the conditions inside the inner chamber 120.

A temperature sensor provides data on the temperature at its location within the pasteurization tunnel 100. There may be multiple temperature sensors throughout the pasteurization tunnel 100 including within the substrate and within the air circulation subsystem. Data regarding temperature is critical to the functioning of the pasteurization tunnel as specific temperatures are required at various stages for pasteurization to be successful. At least one temperature sensor within the air circulation subsystem may be present near the first open end 131 as the air is entering into the bottom of the inner chamber 120.

At least one temperature sensor may be present within the substrate. In an embodiment with multiple cartridges a temperature sensor may be present in each cartridge.

In some embodiments, there may be a temperature sensor at the bottom of the substrate and a temperature sensor at the top of the substrate to determine a temperature gradient across the substrate. In yet other embodiments there may be multiple temperature sensors at multiple depths within the substrate to measure a temperature gradient. When the gradient is not as desired, the airflow through the substrate may be altered by adjusting the rpm of the circulation fan 138.

The air circulation loop 130 may include ports into which sensors can be placed, in particular oxygen and/or temperature sensors.

An airflow sensor provides data regarding the rate of flow of air through the air circulation subsystem and, therefore, through the substrate. The airflow sensor may comprise a pitot tube for measuring airflow. The air circulation loop 130 may have an extended section which creates laminar flow of air for pitot tube measurements.

In other embodiments, airflow sensors which are not pitot tube-based may be used.

Measurement of airflow may or may not be critical for the real-time operation of a single pasteurization tunnel but data regarding which rates of airflow were successful in a given configuration of a pasteurization tunnel can be extrapolated to other configurations. That is, airflow data from a given configuration of the pasteurization tunnel can be applied to a different configuration (e.g., a larger volume) so that the actuators, i.e., circulation fan, return air damper, and fresh air damper, can be adjusted to achieve the same successful flow rate and in turn achieve successful oxygen levels and temperatures.

A moisture sensor may be used to measure water levels within the substrate. In an embodiment with cartridges, there may be a moisture sensor in each cartridge. A humidity sensor may be used to measure water levels of the air within the inner chamber 120 or in the air circulation loop 130 after the second open end 132.

As described above, the parameters for pasteurization may include substrate recipes/formulations, substrate particle size and/or shape, pasteurization times, pasteurization temperatures, moisture content, form factor, air flow, etc. Optimization of the experimental parameters may be performed using AI or modern computational techniques, such as Bayesian optimization, to determine which parameters to investigate based on a higher likelihood of success.

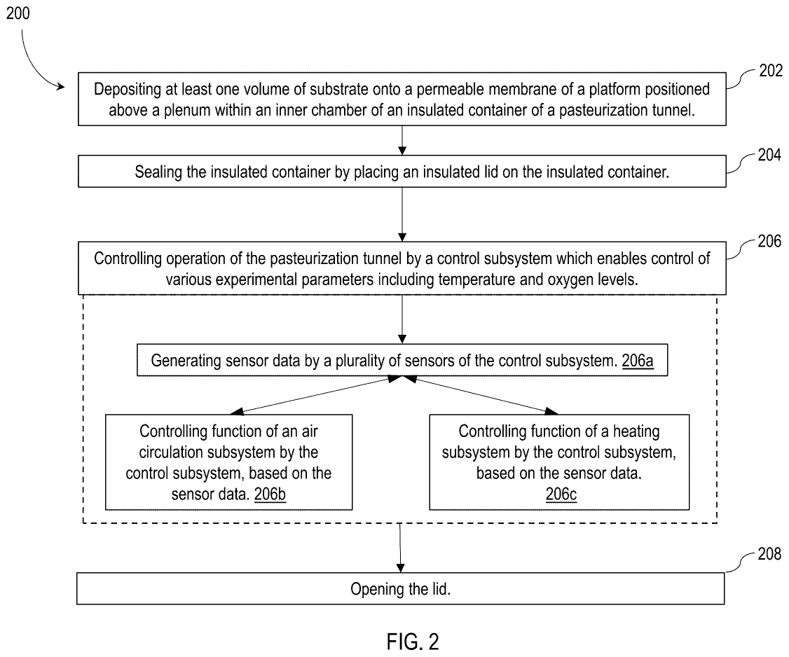

FIG. 2 is a flow diagram of a method of operating a pasteurization tunnel similar to pasteurization tunnel 100 of FIG. 1.

The pasteurization tunnel includes an insulation container with an inner chamber, a lid, a platform within the inner chamber onto which substrate may be deposited, a plenum within the inner chamber which is below the platform wherein the platform comprises an air and moisture permeable membrane, an air circulation subsystem, a heating subsystem, and a control subsystem.

At step 202, at least one volume of substrate is deposited onto the platform above the plenum, wherein the permeable membrane is between the substrate and the plenum. In some embodiments, a cartridge system, as described above, or other means of separation, may be employed to separate units of substrate such that multiple sets of substrate parameters may be studied at the same time.

At step 204, the lid is placed on the insulated container, sealing the insulated container. The lid may be a separate component from the insulated container or may be attached to the insulated container as a hatch or door. The lid may be airtight, or may include at least one exhaust port.

At step 206, the control subsystem is turned on and controls operation of the pasteurization tunnel through various stages of the pasteurization process. The control subsystem enables various experimental parameters including temperature, airflow, and moisture to be met to follow the experimental design for a given pasteurization process.

In an embodiment where cartridges or other means are used to separate distinct volumes of substrate, the experimental parameters controlled by the control subsystem are the same for each distinct volume of substrate. The distinct volumes of substrate may differ in the composition or pre-treatment of the substrate.

The control subsystem comprises a combination of controllers, e.g., microcontrollers or programmable logic controllers (PLC), and circuit boards, e.g., breakout boards, capable of controlling the various components of the pasteurization tunnel as described below.

The control of pasteurization tunnel by the control subsystem has herein been separated into substeps. It is to be understood that these substeps may occur simultaneously, where appropriate.

At step 206a, the control subsystem generates sensor data by a plurality of sensors. The sensors include temperature sensors, oxygen sensors, and airflow sensors. The sensors may also include carbon monoxide sensors, carbon dioxide sensors, moisture sensors, and humidity sensors. During the different stages of the pasteurization process, certain sensors may be turned on or off as necessary.

At step 206b, the control subsystem controls functioning of the air circulation subsystem. The functioning of the air circulation subsystem is dependent on the sensor data generated by the plurality of sensors as well as the predetermined experimental parameters (i.e., the parameters as designed for a specific pasteurization process). The air circulation subsystem includes an air circulation loop, a return air damper, a fresh air inlet, a fresh air damper, and a circulation fan. The air circulation subsystem causes air to flow through the substrate with air passing through a first open end of the air circulation loop, through the substrate, and into a second open end of the air circulation loop. Air flow within the air circulation subsystem is controlled by the circulation fan. Circulation of air within the air circulation subsystem is also controlled by the return air damper. Fresh air enters the system through the fresh air inlet under the control of the fresh air damper.

The control subsystem controls the actuation of the circulation fan, the return damper, and the fresh air damper. During different stages of the pasteurization process, the dampers may be open or closed and the circulation fan may change the rotations per minute. The air circulation subsystem is used to reach and to maintain specific parameters throughout the pasteurization process.

For example, a specific O₂ level may be desired to ensure the correct aerobic/anaerobic conditions during a stage of the pasteurization process. The air circulation subsystem may be operated to open the fresh air damper to bring in fresh air to reach the desired O₂ level and then the damper may be controlled to open to a specific extent or to close to maintain the desired O₂ level over time in response to sensor data from at least one oxygen sensor.

As the air circulation subsystem is operated by the control subsystem, the plurality of sensors continue to generate sensor data which is used by the control subsystem to determine if the actuation of the air circulation subsystem is having the desired result.

At step 206c, the control subsystem controls the heating subsystem. In some embodiments, the heating subsystem is used to add supplemental thermal energy to the substrate. The operation of the heating subsystem is dependent on the sensor data generated by the plurality of sensors as well as the predetermined experimental parameters (i.e., the parameters as designed for a specific pasteurization process). For example, the heating subsystem may be turned on at the beginning of the pasteurization process to provide thermal energy for the substrate to reach a desired temperature, the heating subsystem may then be turned off and on intermittently throughout the rest of the pasteurization process, based on sensor data from at least one temperature sensor, to maintain the desired temperature (which changes throughout the process).

The heating subsystem may comprise a heater which heats through convection, conduction, and/or radiation. The heating subsystem may employ steam injection. In other embodiments, the heating subsystem may employ any means of heating which can heat the air and/or the substrate. In some embodiments, there may be no heating subsystem.

The control subsystem controls the actuation of the heating subsystem. During different stages of the pasteurization process, the heating subsystem may output thermal energy. The heating subsystem is used to reach and to maintain specific parameters throughout the pasteurization process.

As the heating subsystem is operated by the control subsystem, the plurality of sensors continue to generate sensor data which is used by the control subsystem to determine if the actuation of the heating subsystem is having the desired result.

At least one oxygen sensor measures the O₂ levels within the pasteurization tunnel and the measurement is used to determine if more or less fresh air is required for maintaining the optimal aerobic (or anaerobic) conditions. The fresh air damper and/or the circulation fan may be used to change the O₂ levels within the tunnel.

Temperature sensors are used to measure the temperature of the substrate to ensure an optimal pasteurization temperature is reached and maintained. In some embodiments, there may be multiple temperature sensors placed throughout the substrate to measure a temperature gradient within the substrate. In response to temperature measurements, the heating subsystem may introduce thermal energy into the insulation chamber (e.g., directly into the substrate or by heating the air), and/or may increase or decrease the rpm of the circulation fan.

Airflow sensors are used to measure the rate of airflow through the inner chamber and/or air circulation subsystem and, therefore, through the substrate. In some embodiment, a pitot tube may be used to measure airflow.

Carbon monoxide and carbon dioxide sensors may be used to measure the levels of CO and CO₂ in the inner chamber and/or air circulation subsystem.

Moisture sensors may be used to measure the water level within substrate. Humidity sensors may be used to measure the water level within the air.

The various parameters which the control subsystem operates to reach or maintain during the pasteurization process, e.g., pasteurization temperatures, moisture content, air flow, pasteurization times, etc., may be calculated using AI or other computational techniques, for example Bayesian optimization.

The control subsystem may control the sensors, the heating subsystem, and the air circulation subsystem automatically, manually, or any combination thereof.

At step 208, the once pasteurization is complete, the lid of the pasteurization tunnel is opened or removed. The substrate may be inoculated with the organism of choice within the pasteurization tunnel or the substrate may be removed from the pasteurization tunnel and then inoculated.

If the substrate is inoculated inside the inner chamber, the pasteurization tunnel may be used to perform a spawn run or colonization of the substrate using the temperature regulation and controlled aeration provided by the pasteurization tunnel.

An example pasteurization process may include the following:

With the return air damper fully open and the fresh air damper fully closed the substrate may be heated to the desired pasteurization temperature. The heater may provide thermal energy to reach the desired pasteurization temperature.

After the desired pasteurization temperature is reached, the control subsystem actuates the return air damper, the fresh air damper, the circulation fan, and possibly the heating subsystem to maintain the temperature for a desired amount of time.

After the desired amount of time, the control subsystem actuates the return air damper, the fresh air damper, and the circulation fan to cool the substrate at a controlled rate over time until reaching a desired conditioning temperature.

After a desired amount of time at the conditioning temperature, the control subsystem closes the return air damper, opens the fresh air damper, and actuates the circulation fan to quickly bring the temperature down to a cooled temperature which will not harm the desired growth organism.

While the above description provides examples of one or more apparatus, methods, or systems, it will be appreciated that other apparatus, methods, or systems may be within the scope of the claims as interpreted by one of skill in the art.

1. A small scale pasteurization tunnel system for microbial pasteurization of growth substrate, comprising:
an insulated container and an insulated lid, wherein when the insulated lid is positioned to close the insulated container, an airtight inner chamber is formed by the insulated container and the insulated lid, wherein growth substrate is placed within the inner chamber for pasteurization;
an air circulation subsystem comprising:
an air circulation loop comprising airtight ducting which directs airflow through the substrate, wherein air flows out of a first end of the air circulation loop into the substrate and air flows out of the substrate and into a second end of the air circulation loop;
a circulation fan which controls the speed and direction of airflow through the air circulation loop;
a fresh air inlet which connects to the air circulation loop to provide fresh air;
a return air damper which controls a resistance of return air entering into the air circulation loop at the second open end;
a fresh air damper which controls a resistance of fresh air entering into the air circulation loop;
an exhaust port to allow air to pass from the inner chamber to an exterior of the insulated container; and
a control subsystem for monitoring data from a plurality of sensors and controlling the circulation fan, the return air damper, and the fresh air damper.

2. The system of claim 1 further comprising a cartridge system, wherein at least one cartridge is placed within the inner chamber, and wherein the at least one cartridge holds substrate and allows air to flow through the substrate.

3. The system of claim 2 wherein at least two cartridges are placed within the inner chamber and wherein pasteurization parameters within each of the at least two cartridges are different.

4. The system of claim 1 further comprising a heating subsystem for providing thermal energy to facilitate microbial activity within the substrate, wherein the heating subsystem is controlled by the control subsystem.

5. The system of claim 6 wherein the heating subsystem employs at least one of convection, conduction, radiation, or steam injection.

6. The system of claim 1 wherein the control subsystem includes at least one oxygen sensor to measure oxygen levels.

7. The system of claim 1 wherein the control subsystem includes a carbon monoxide sensor to measure carbon monoxide levels.

8. The system of claim 1 wherein the control subsystem includes a carbon dioxide sensor to measure carbon dioxide levels.

9. The system of claim 1 wherein the control subsystem includes at least one airflow sensor measure of flow rate of the air through the air circulation subsystem.

10. The system of claim 1 wherein the control subsystem includes at least one temperature sensor to measure a temperature of the substrate.

11. The system of claim 1 wherein the control subsystem includes a plurality of temperature sensors within the substrate to measure a temperature gradient across the substrate.

12. The system of claim 1 wherein the control subsystem includes at least one temperature sensor to measure a temperature of the air.

13. The system of claim 1 wherein the control subsystem includes at least one humidity sensor to measure a water level of the air within the inner chamber.

14. The system of claim 1 wherein the control subsystem includes at least one moisture sensor to measure a water level within the substrate.

15. A method of operating a miniature pasteurization tunnel comprising an insulated container, an air circulation subsystem, and a control subsystem, the method comprising:
placing at least one volume of substrate on a platform within the insulated container, wherein the platform comprises a plane of permeable membrane above a plenum;
sealing the insulated container with an insulated lid;
controlling substrate parameters of the at least one volume of substrate by the control subsystem based on a plurality of experimental parameters, wherein the substrate parameters include at least temperature and oxygen level, and wherein the control subsystem controls the substrate parameters by:
generating sensor data from a plurality of sensors within the pasteurization tunnel, wherein the plurality of sensors includes at least one temperature sensor and at least one oxygen sensor; and
controlling air flow through an air circulation loop of the air circulation subsystem and through the at least one volume of substrate by actuating a return air damper of the air circulation loop, a fresh air damper of a fresh air inlet of the air circulation subsystem, and a circulation fan of the air circulation subsystem based on the sensor data from the at least one temperature sensor and the at least one oxygen sensor.

16. The method of claim 15 wherein the pasteurization tunnel further comprises a heating subsystem and controlling the temperature of the substrate further comprising controlling the heating subsystem, by the control subsystem, to provide thermal energy to the substrate.

17. The method of claim 16 wherein the heating subsystem provides thermal energy by at least one of conduction, convection, radiation, and steam injection.

18. The method of claim 15 wherein the plurality of sensors includes at least one airflow sensor to measure airflow throughout the pasteurization tunnel.

19. The method of claim 15 wherein the plurality of sensors includes at least one moisture sensor to measure a water level within the substrate.

20. The method of claim 15 wherein the plurality of sensors includes at least one humidity sensor to measure a water level within the air.
